(19) United States
(12) Patent Application Publication
(10) Pub. No.: US 2014/0191062 A1
(43) Pub. Date: Jul. 10, 2014

(54) LIQUID EJECTION HEAD AND LIQUID EJECTION APPARATUS

(71) Applicants: Naoto Sasagawa, Kawasaki-shi (JP); Koichi Kitakami, Tokyo (JP)

(72) Inventors: Naoto Sasagawa, Kawasaki-shi (JP); Koichi Kitakami, Tokyo (JP)

(73) Assignee: CANON KABUSHIKI KAISHA, Tokyo (JP)

(21) Appl. No.: 14/238,528

(22) PCT Filed: Sep. 10, 2012
(86) PCT No.: PCT/JP2012/073759

§ 371 Date: Feb. 12, 2014

(30) Foreign Application Priority Data
Sep. 20, 2011 (JP) 2011-204601

(51) Int. Cl. B05B 17/00

(52) U.S. Cl. CPC B05B 17/0646
USPC 239/75

(57) ABSTRACT

Provided is a liquid ejection head, including a pressure chamber in which a liquid flows, at least a part of a wall surface of the pressure chamber being formed of a piezoelectric member; an ejection orifice for ejecting the liquid in the pressure chamber pressurized by deformation of the piezoelectric member; a temperature control liquid flow path in which a temperature control liquid flows, the temperature control liquid flow path being provided independently from the pressure chamber and formed so as to be adjacent to the pressure chamber via the wall surface of the pressure chamber, at least a part of a wall surface of the temperature control liquid flow path being formed of the piezoelectric member; and a circulation liquid flow path communicating with the temperature control liquid flow path, for circulating the temperature control liquid.

### TECHNICAL FIELD

The present invention relates to a configuration for controlling a temperature of a liquid ejection head for ejecting liquid by a piezoelectric element.

### BACKGROUND ART

Various proposals have been made regarding a liquid ejection head to be mounted on a liquid ejection apparatus typified by an ink-jet recording apparatus. Of those, a liquid ejection head using a piezoelectric element as a source for generating liquid ejection energy has an advantage of being capable of handling any kind of liquid (ink) to be ejected.

In recent years, an attempt has been made to use an ink-jet recording apparatus for commercial printing such as print on demand (POD), and there is a demand for an increase in printing speed. For this purpose, it is requested that the drive frequency of a liquid ejection head be enhanced.

On the other hand, in order to reduce deformation (curling, cockling, etc.) of a recording medium caused by water contained in ink to be ejected from a liquid ejection head, the use of high-viscosity ink reduced in water amount is being considered.

FIGS. 12A to 12C illustrate an example of a conventional liquid ejection head. FIG. 12A is a side view of the liquid ejection head. FIG. 12B is a cross-sectional view of the liquid ejection head taken along line 12B-12B of FIG. 12A. FIG. 12C is a cross-sectional view of the liquid ejection head taken along line 12C-12C of FIG. 12A. As illustrated in FIG. 12B, multiple grooves are arranged in a piezoelectric member 12 substantially in parallel with each other at a predetermined interval. One end of each groove in a longitudinal direction and an upper portion of each groove are opened and respectively sealed with a nozzle plate 8 and a cover plate 16 forming a part of the piezoelectric member 12. Each groove is used as a pressure chamber 13. In the nozzle plate 8, an ejection orifice 10 communicating with each pressure chamber 13 is formed so that liquid is ejected from the ejection orifice 10. At an end of the groove in the longitudinal direction on an opposite side of the ejection orifice 10, a diaphragm plate 17 having a diaphragm aperture 18 which communicates with each pressure chamber 13 is provided, and the pressure chamber 13 communicates with a common liquid chamber 20 through the diaphragm aperture 18. In this manner, liquid is supplied from the common liquid chamber 20 to each pressure chamber 13.

The above-mentioned configuration has high ejection efficiency and can generate a large ejection pressure, and hence the configuration is suitable for ejecting high-viscosity liquid at a high frequency. On the other hand, in the liquid ejection head using the piezoelectric element, in general, a dielectric loss depending on a drive voltage to be applied to the piezoelectric element and a frequency thereof occurs to raise the temperature. The heat generated by the piezoelectric element may degrade electric characteristics of the piezoelectric element and ink characteristics.

As a technology of ejecting high-viscosity liquid which cannot be ejected at room temperature, there is known a technology of ejecting liquid by raising the temperature thereof to lower the viscosity thereof. However, the viscosity and surface tension of liquid depends on the temperature. Therefore, if the temperature cannot be regulated precisely, ejection performance such as ejection amount and ejection speed varies to have a serious influence on image quality.

Patent Literature 1 discloses a technology of regulating the temperature of ink. According to the technology disclosed in Patent Literature 1, multiple grooves arranged in a piezoelectric member substantially in parallel with each other at a predetermined interval are used as pressure chambers and air flow paths alternately in an arrangement direction. By supplying air having the regulated temperature into the air flow paths, the temperature of ink is regulated.

### CITATION LIST

### Patent Literature

PTL 1: Japanese Patent Application Laid-Open No. 2006-181819

### SUMMARY OF INVENTION

### Technical Problem

The exothermic energy amount caused by a dielectric loss increases in proportion to the square of an applied voltage and increases in proportion to the frequency. In the case of ejecting high-viscosity liquid, it is necessary to supply a piezoelectric element with a voltage larger than that in the case of ejecting low-viscosity liquid, and when liquid droplets are ejected at a higher frequency, the heat generation from the piezoelectric element becomes excessive, which may degrade electric characteristics.

In the technology disclosed in Patent Literature 1, air with the temperature regulated is sent to the air flow paths. In order to absorb the heat generated by ejecting high-viscosity liquid at a high frequency, a high heat transfer coefficient is required, and hence it is difficult to sufficiently cool the piezoelectric element with air.

In the case of controlling the temperature of ink, it is also difficult to sufficiently convey heat with air having a low heat transfer coefficient. In addition, the temperature of air tends to vary depending on the pressure, and hence, it is difficult to regulate the temperature of ink with air precisely.

### Solution to Problem

According to the present invention, there is provided a liquid ejection head, including:

a pressure chamber in which a liquid flows, at least a part of a wall surface of the pressure chamber being formed of a piezoelectric member;

an ejection orifice for ejecting the liquid in the pressure chamber pressurized by deformation of the piezoelectric member;

a temperature control liquid flow path in which a temperature control liquid flows, the temperature control liquid flow path being provided independently from the pressure chamber and formed so as to be adjacent to the pressure chamber via the wall surface of the pressure chamber, at least a part of a wall surface of the temperature control liquid flow path being formed of the piezoelectric member; and

a circulation liquid flow path communicating with the temperature control liquid flow path, for circulating the temperature control liquid.

Further features of the present invention will become apparent from the following description of exemplary embodiments with reference to the attached drawings.

### BRIEF DESCRIPTION OF DRAWINGS

FIG. 1 is a schematic structural view of a liquid ejection apparatus according to an embodiment of the present invention.

FIG. 2A is a side view of a liquid ejection head according to a first embodiment of the present invention.

FIG. 2B is a cross-sectional view of the liquid ejection head taken along line 2B-2B of FIG. 2A according to the first embodiment of the present invention.

FIG. 2C is a cross-sectional view of the liquid ejection head taken along line 2C-2C of FIG. 2A according to the first embodiment of the present invention.

FIG. 3 is an exploded perspective view of the liquid ejection head illustrated in FIGS. 2A, 2B and 2C.

FIG. 4 is a conceptual diagram illustrating a temperature control liquid flow path of the liquid ejection head illustrated in FIGS. 2A, 2B and 2C.

FIG. 5 is a conceptual diagram illustrating a pump of the liquid ejection head illustrated in FIGS. 2A, 2B and 2C.

FIG. 6 is a conceptual diagram illustrating the temperature control liquid flow path of the liquid ejection head illustrated in FIGS. 2A, 2B and 2C.

FIG. 7 is an exploded perspective view of a liquid ejection head according to a second embodiment of the present invention.

FIG. 8 is a schematic structural view of a liquid ejection head according to a third embodiment of the present invention.

FIG. 9 is an exploded perspective view of the liquid ejection head illustrated in FIG. 8.

FIG. 10 is an exploded perspective view of a liquid ejection head according to a fourth embodiment of the present invention.

FIG. 11 is an exploded perspective view of a liquid ejection head according to a fifth embodiment of the present invention.

FIG. 12A is a side view of a conventional liquid ejection head.

FIG. 12B is a cross-sectional view of the conventional liquid ejection head taken along line 12B-12B of FIG. 12A.

FIG. 12C is a cross-sectional view of the conventional liquid ejection head taken along line 12C-12C of FIG. 12A.

### DESCRIPTION OF EMBODIMENTS

Hereinafter, a liquid ejection head is described in detail by way of embodiments with reference to the drawings. Note that, the present invention is not limited by the following embodiments.

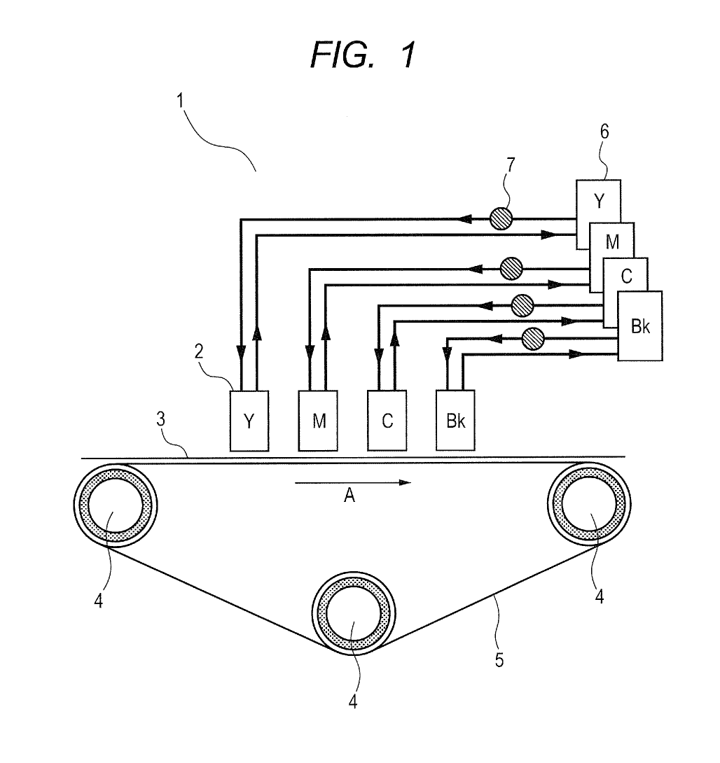

First, referring to FIG. 1, a liquid ejection apparatus 1 to which a liquid ejection head of this embodiment can be applied preferably is described. The liquid ejection apparatus 1 includes a conveying belt 5 formed of an endless belt which is driven under a tension applied by conveying rollers 4. A recording medium 3 is conveyed on the conveying belt 5 in a recording medium conveyance direction A by the conveying belt 5 driven by the conveying rollers 4.

The liquid ejection apparatus 1 includes four liquid ejection heads 2 corresponding to four colors (e.g., yellow (Y), magenta (M), cyan (c), and black (Bk)). The four liquid ejection heads 2 are placed successively in any order in the recording medium conveyance direction A. Each liquid ejection head 2 includes a nozzle plate 8 (described later), and in the nozzle plate 8, multiple ejection orifices 10 (described later) are formed in a range corresponding to the width (in a direction orthogonal to the drawing sheet) of the recording medium 3. Ink of each color stored in an ink tank 6 is fed to each liquid ejection head 2 by a pump 7 while the recording medium 3 is being conveyed, and the ink is ejected from the ejection orifices 10 of each liquid ejection head 2. In this way, full-color recording can be performed on the recording medium 3 at a high speed.

### First Embodiment

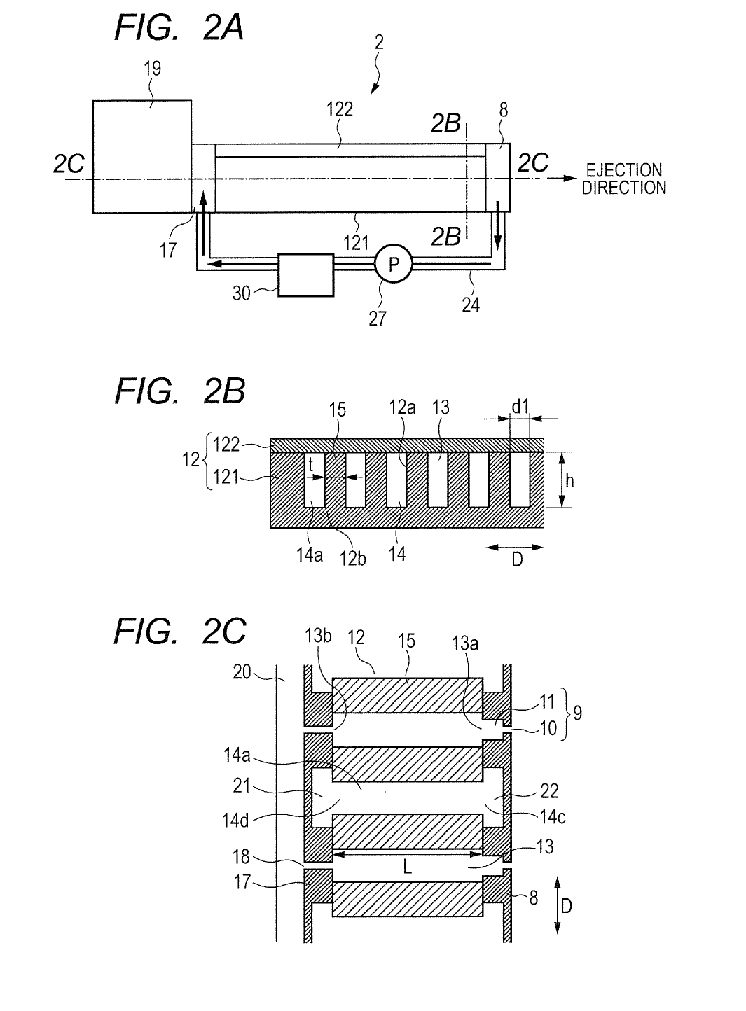

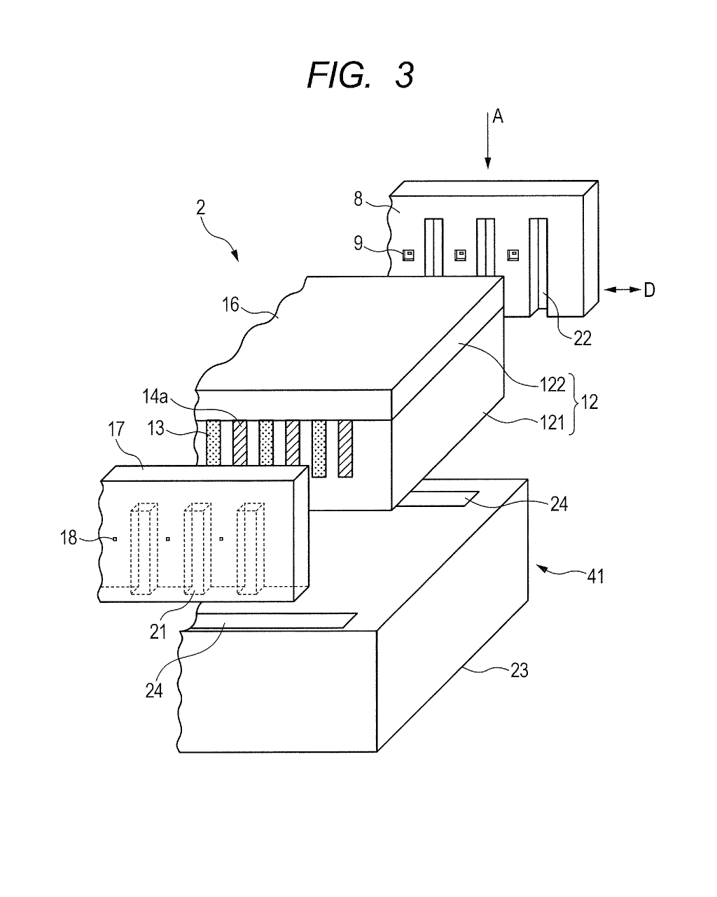

FIGS. 2A to 7 illustrate a liquid ejection head according to a first embodiment of the present invention. FIG. 2A is a side view of the liquid ejection head. FIG. 2B is a cross-sectional view of the liquid ejection head taken alone line 2B-2B of FIG. 2A. FIG. 2C is a cross-sectional view of the liquid ejection head taken along line 2C-2C of FIG. 2A. FIG. 3 is an exploded perspective view illustrating each member forming the liquid ejection head 2 three-dimensionally.

As illustrated in FIG. 2B, the liquid ejection head 2 includes a piezoelectric member 12. The piezoelectric member 12 includes a main body 121 formed of a piezoelectric body and a cover plate 122. In the piezoelectric member 12, a pressure chamber 13 which communicates with each ejection orifice 10 and holds liquid to be ejected from each ejection orifice 10 and a first temperature control liquid flow path 14a in which a first temperature control liquid flows are formed alternately in a direction D orthogonal to the recording medium conveyance direction A. Multiple pressure chambers 13 are provided so as to correspond to the multiple ejection orifices 10. The first temperature control liquid flow path 14a is provided independently from the pressure chamber 13.

The pressure chamber 13 and the first temperature control liquid flow path 14a are formed of a groove 12a formed in the main body 121 of the piezoelectric member 12 and the cover plate 122 forming a part of the piezoelectric member 12. Consequently, two side surfaces of the pressure chamber 13 are formed of partition walls 15 made of a piezoelectric body, one side surface thereof is formed of a bottom surface 12b of the piezoelectric member 12, and the remaining side surface is formed of the cover plate 122. A through-hole forming the pressure chamber 13 and the first temperature control liquid flow path 14a may be formed in the piezoelectric body, instead of using the cover plate 122. Specifically, in the piezoelectric member 12, at least a part of the wall surface of the pressure chamber 13 may be formed of a piezoelectric body, and the whole of the pressure chamber 13 is not required to be formed of a piezoelectric body.

In a part of the piezoelectric member 12 forming the partition wall 15 of the pressure chamber 13, an electrode wiring (not shown) for supplying a drive voltage is provided. When a drive voltage is applied independently to each partition wall 15, the piezoelectric member 12 is deformed, and liquid pressurized by the deformation of the piezoelectric member 12 is ejected from the ejection orifice 10 in the longitudinal direction of the pressure chamber 13.

In one example, the pressure chamber 13 and the first temperature control liquid flow path 14a have a width d1 of 70 μm, a depth h of 300 μm, and a length L of 10 mm, and each partition wall 15 has a thickness t of 70 μm.

The nozzle plate 8 includes multiple nozzles 9, each of which communicates with an outlet opening 13a of the pressure chamber 13 and ejects liquid in the pressure chamber 13. As illustrated in FIG. 2C, the nozzle 9 is formed of the ejection orifice 10 and a widening portion 11 having a flow path cross section which is larger than that of the ejection orifice 10. The ejection orifices 10 are arranged in a row in the direction D orthogonal to the recording medium conveyance direction A. In one example, the thickness of the nozzle plate 8 is 200 μm. The ejection orifice 10 has a cylindrical shape having a diameter of 10 μm and a length of 17 μm, and the widening portion 11 is a prismatic shape having a cross-section size of 50 μm×50 μm in FIG. 2C. The ejection orifice 10 and the widening portion 11 may be tapered.

In the nozzle plate 8, a first outlet side flow path 22 which connects an outlet opening 14c of the first temperature control liquid flow path 14a to a first temperature regulating unit 41 is formed in a groove shape. The first outlet side flow path 22 has a width of 120 μm and a height (thickness direction of the nozzle plate 8) of 150 μm, and extends to the side surface of the nozzle plate 8 along the nozzle plate 8.

On an end face of the piezoelectric member 12 on an opposite side of the nozzle plate 8, a diaphragm plate 17 is provided. The diaphragm plate 17 includes a diaphragm aperture 18 which communicates with an inlet opening 13b of the pressure chamber 13 and supplies liquid to the pressure chamber 13. Multiple diaphragm apertures 18 are provided so as to correspond to the multiple pressure chambers 13. The diaphragm plate 17 has a thickness of 200 μm, and the diaphragm aperture 18 which communicates with the pressure chamber 13 has a rectangular shape of 50 μm×50 μm. The diaphragm plate 17 includes a first inlet side flow path 21 connecting the first temperature regulating unit 41 to an inlet opening 14d of the first temperature control liquid flow path 14a. The first inlet side flow path 21 is formed in a groove shape and extends to the side surface of the diaphragm plate 17 along the diaphragm plate 17. The first inlet side flow path 21 has a width of 120 μm and a height of 150 μm.

In a manifold 19, a common liquid chamber 20 in which liquid flows and which communicates with each pressure chamber 13 via the diaphragm aperture 18 is formed.

The first inlet side flow path 21 and the first outlet side flow path 22 are connected to each other via a circulation liquid flow path 24 formed in a circulation liquid flow path forming member 23. Consequently, a circulation flow path formed of the first inlet side flow path 21, the first temperature control liquid flow path 14a, the first outlet side flow path 22, and the circulation liquid flow path 24 is formed, and the temperature of the piezoelectric member 12 can be controlled by allowing the first temperature control liquid to flow in the circulation flow path.

In this embodiment, although the first outlet side flow path 22 is provided in the nozzle plate 8, and the first inlet side flow path 21 is provided in the diaphragm plate 17, these arrangements may be reversed. Specifically, the first inlet side flow path 21 may be provided in the nozzle plate 8, and the first outlet side flow path 22 may be provided in the diaphragm plate 17. The first inlet side flow path 21 and the first outlet side flow path 22 may be formed in the piezoelectric member 12 in a groove shape. Grooves may be provided respectively in the piezoelectric member 12 and the diaphragm plate 17 or the nozzle plate 8 and integrated to form the first inlet side flow path 21 and the first outlet side flow path 22.

It is desired that the first temperature control liquid be another liquid than the liquid to be ejected from the ejection orifice 10, and for example, water, petroleum-derived lubricating oil, silicone oil, or the like can be used.

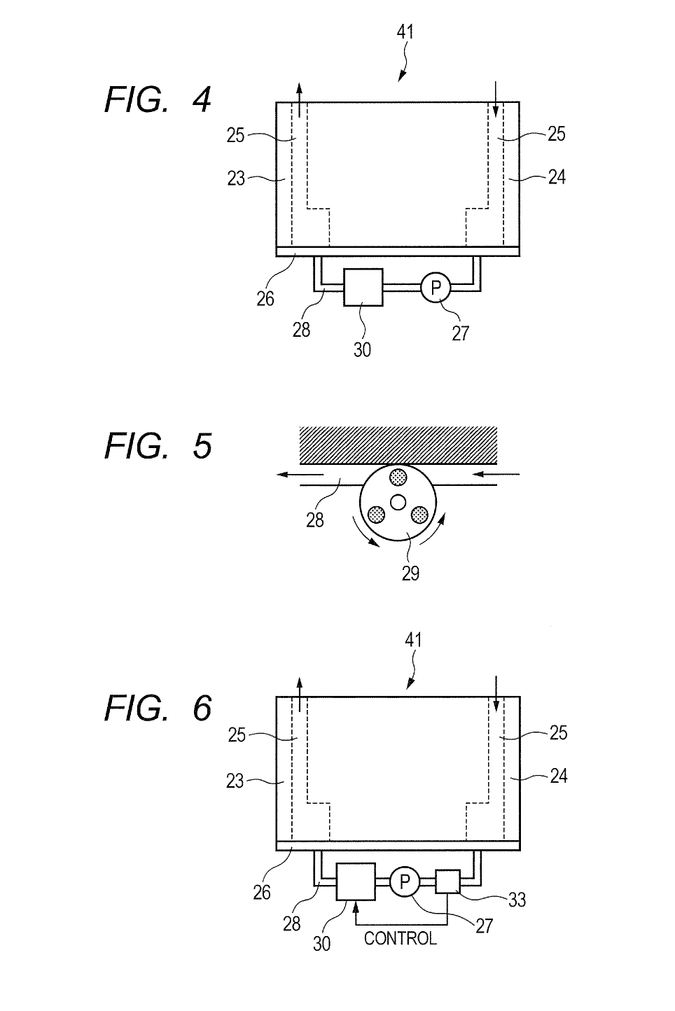

FIG. 4 is a schematic structural view of the first temperature regulating unit 41 for regulating the temperature of the first temperature control liquid which flows in the first temperature control liquid flow path 14a. The first temperature regulating unit 41 includes the circulation liquid flow path forming member 23, and in the circulation liquid flow path forming member 23, two through-holes 25 for directly connecting the first inlet side flow path 21 and the first outlet side flow path 22 to each other are formed. Ends of the through-holes 25 on an opposite side of the first inlet side flow path 21 and the first outlet side flow path 22 are closed by a lid member 26 having a coupling for connection with a tube 28. The two through-holes 25 and the tube 28 form the circulation liquid flow path 24. The tube 28 includes a pump 27 and a temperature control unit 30. As the temperature control unit 30, a Peltier element can be used.

FIG. 5 illustrates the concept of the pump 27. In this embodiment, as the pump 27, a tube pump is used. When the tube 28 is pressurized to be deformed by a roller 29 of the pump 27, the liquid in the tube 28 is pushed out, and the first temperature control liquid can be fed from the first outlet side flow path 22 to the first inlet side flow path 21 under pressure.

Hereinafter, a relationship between the exothermic energy amount of the piezoelectric member 12 and the endothermic energy amount by the first temperature control liquid is shown. Expression (1) represents the exothermic energy amount caused by a dielectric loss of the piezoelectric body forming the piezoelectric member 12.

P=πf∈dE² tan θ Expression (1)

Assuming that f (drive frequency) is 50 kHz, ∈ (dielectric constant) is 1.5e⁻⁸ F/m, d (thickness of a piezoelectric element) is 70 μm, E (electric field) is 714 kV/m, and tan δ (dielectric loss) is 0.32%, the exothermic energy amount P is about 270 W/m².

Next, Expression (2) represents a heat transfer coefficient by water.

Expression (2)

$$α = 0.664 \frac{{u}^{1 \text{/} 2} {ρ}^{1 \text{/} 3} {C}_{p}^{1 \text{/} 3} {λ}^{2 \text{/} 3}}{{L}^{1 \text{/} 2} {v}^{1 \text{/} 6}}$$

It is assumed that u (flow velocity of water) is 0.04 m/s, ρ (density of water) is 996 kg/m³, Cₚ (specific heat of water) is 4,177 J/(kg·K), A (heat conductivity) is 0.6104 W/(m·K), L (representative length) is 5.15 mm, ν (dynamic viscosity) is 8.57e⁻⁷ m²/s. At this time, the heat transfer coefficient is 2,198 W/(m²·K).

Assuming that a heat generating area is the same as a heat absorbing area, the first temperature control liquid flow path 14a absorbs the heat generated from the partition walls 15 on both sides, and hence the first temperature control liquid flow path 14a absorbs an exothermic energy amount of 540 W/m² at a heat transfer coefficient of 2,198 W/(m²·K). Accordingly, a temperature rise caused by the dielectric loss of the piezoelectric member 12 can be suppressed at a water temperature rise of 0.25 K.

FIG. 6 is a schematic structural view of the first temperature regulating unit 41 according to another embodiment of the present invention. In the first temperature regulating unit 41 illustrated in FIG. 6, in order to control the temperatures of the piezoelectric member 12 and the first temperature control liquid further precisely, a temperature sensor 33 for measuring the temperature of the first temperature control liquid is provided in the circulation liquid flow path 24. How much energy the first temperature control liquid has received from the piezoelectric member 12 is known from the temperature of the first temperature control liquid measured by the temperature sensor 33, and hence, based on the energy, the temperature of the piezoelectric member 12 can be obtained. By controlling a current which flows in the Peltier element that is the temperature control unit 30 based on a difference between the target temperature of the piezoelectric member 12 and the actual temperature, the temperature of the piezoelectric member 12 can be controlled precisely.

By regulating the temperature of the piezoelectric member 12 so that the temperature of the piezoelectric member 12 becomes the same as that of liquid intended to be used in the case of ejecting liquid reduced in viscosity by raising the temperature thereof, the liquid can be controlled to a desired temperature precisely. According to this embodiment, by controlling the temperature of the first temperature control liquid, the temperature of the piezoelectric member 12 and the temperature of liquid to be ejected can be controlled precisely.

### Second Embodiment

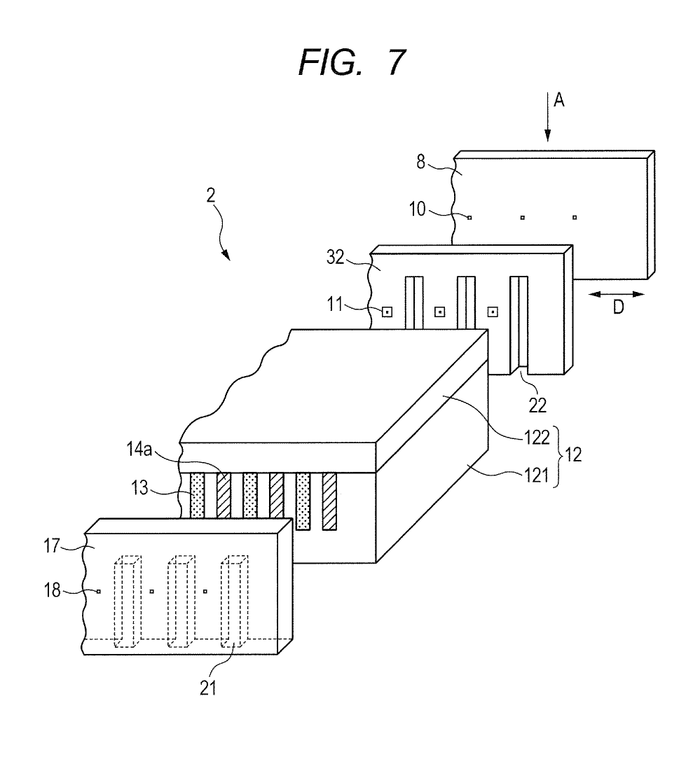

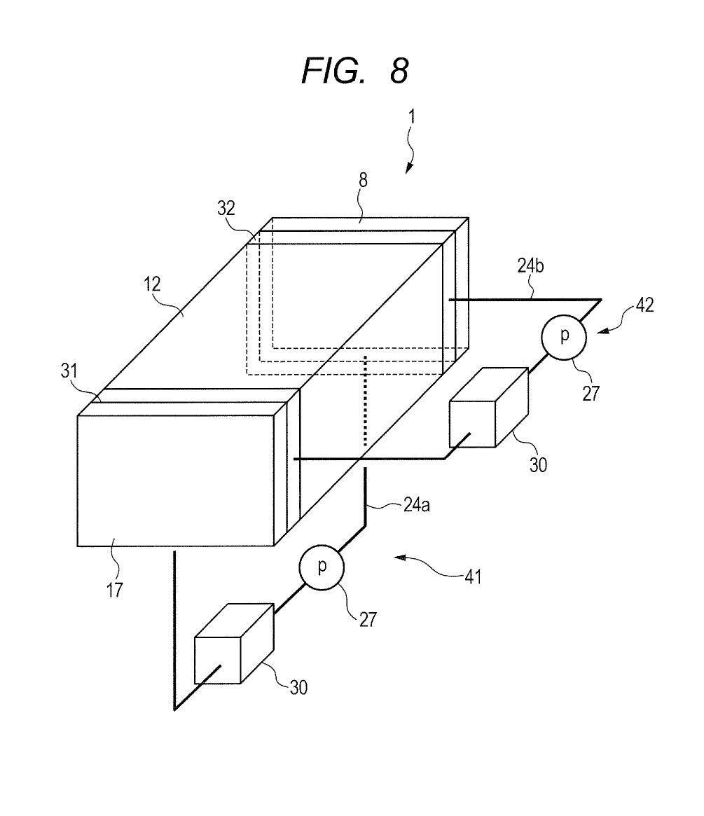

Next, a second embodiment of the present invention is described. In the following, the descriptions of the components which are common to those of the first embodiment are omitted. FIG. 7 is an exploded perspective view of a liquid ejection head 2 according to this embodiment.

In the liquid ejection head 2 of this embodiment, a nozzle plate side intermediate plate 32 is provided between a piezoelectric member 12 and a nozzle plate 8. In the nozzle plate side intermediate plate 32, a first outlet side flow path 22 is formed in a groove shape, and the first outlet side flow path 22 extends to the side surface of the nozzle plate side intermediate plate 32 along the nozzle plate side intermediate plate 32. The nozzle plate side intermediate plate 32 also includes a widening portion 11 which communicates with a pressure chamber 13 and an ejection orifice 10 and has a flow path cross section larger than the ejection orifice 10. In one example, the nozzle plate side intermediate plate 32 has a thickness of 150 μm, the widening portion 11 has a cross-sectional shape of 50 μm×50 μm, and the first outlet side flow path 22 has a width of 120 μm. The nozzle plate 8 has a thickness of 17 μm, and the ejection orifice 10 in a cylindrical shape having a diameter of 10 μm is formed in the nozzle plate 8. The configurations of a diaphragm plate 17, a manifold 19, and a circulation liquid flow path 24 are the same as those of the first embodiment.

For forming the first outlet side flow path 22, the nozzle plate 8 having the ejection orifice 10 formed therein and the nozzle plate side intermediate plate 32 having the widening portion 11 formed therein are bonded to each other, and the first outlet side flow path 22 is formed in a groove shape in the nozzle plate side intermediate plate 32 by dicing.

The first outlet side flow path 22 may be provided in the diaphragm plate 17, and a first inlet side flow path 21 may be provided in the nozzle plate side intermediate plate 32. The nozzle plate side intermediate plate 32 may be provided on a side of the nozzle plate 8 opposite to the piezoelectric member 12.

In this embodiment, the ejection orifice 10 and the widening portion 11 are formed of different members, and hence it is not necessary to form a structure having a level difference (level difference formed between the ejection orifice 10 and the widening portion 11) in one member, which facilitates the production of the liquid ejection head 2.

### Third Embodiment

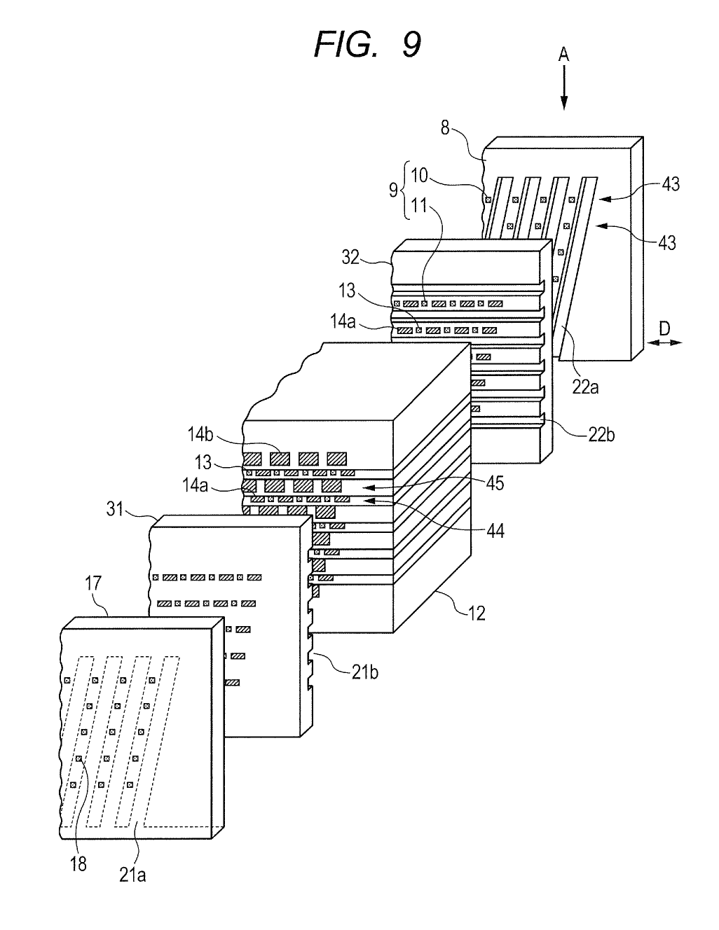

Next, a third embodiment of the present invention is described. In the following, the descriptions of the components which are common to those of the first and second embodiments are omitted. FIG. 8 is a schematic structural view of a liquid ejection apparatus 1 of this embodiment, and FIG. 9 is an exploded perspective view illustrating each member constituting a liquid ejection head 2 three-dimensionally.

In this embodiment, nozzles 9 are placed two-dimensionally. Specifically, multiple nozzle arrays (ejection orifice arrays) 43 are provided in a nozzle plate 8, and each nozzle array 43 includes multiple nozzles 9 arranged in a direction D orthogonal to a recording medium conveyance direction A. The nozzle arrays 43 are placed at an interval in the recording medium conveyance direction A and shifted from each other in the direction D orthogonal to the recording medium conveyance direction A. Due to such an arrangement of the nozzles 9 (ejection orifices), an effective nozzle pitch (the number of the nozzles 9 (ejection orifices) per unit length is herein referred to as a nozzle pitch) can be increased.

In this embodiment, the nozzle pitch of each nozzle array 43 in the direction D orthogonal to the recording medium conveyance direction A is 36 dots per inch (dpi). By providing five nozzle arrays 43 so that the nozzle arrays 43 are shifted from each other in the direction D orthogonal to the recording medium conveyance direction A by ⅕ of the interval between adjacent ejection orifices 10 in the same nozzle array, the effective nozzle pitch can be set to be 180 dpi. The effective nozzle pitch can be further increased by increasing the number of nozzle arrays placed so as to be shifted from each other in the direction D orthogonal to the recording medium conveyance direction A. For example, by placing 20 nozzle arrays so that the nozzle arrays are shifted from each other by 1/20 of the interval between adjacent ejection orifices in the same nozzle array, a nozzle pitch of 720 dpi can be obtained. By placing 40 nozzle arrays so that the nozzle arrays are shifted from each other by 1/40 of the interval between the ejection orifices, a nozzle pitch of 1,440 dpi can be obtained.

In this embodiment, a second temperature control liquid flow path 14b in which a second temperature control liquid flows is provided in a piezoelectric member 12. The second temperature control liquid flow paths 14 is provided independently from a pressure chamber 13 and a first temperature control liquid flow paths 14. Further, a second temperature regulating unit 42 for regulating the temperature of the second temperature control liquid which flows in the second temperature control liquid flow path 14b is provided. The second temperature regulating unit 42 has the same configuration as that of a first temperature regulating unit 41.

In the piezoelectric member 12, multiple pressure chambers 13 corresponding to the multiple ejection orifices 10 are placed. The pressure chamber 13 and the first temperature control liquid flow path 14a are provided alternately in the direction D orthogonal to the recording medium conveyance direction A and form a first array 44. Further, in this embodiment, a second array 45 in which the second temperature control liquid flow path 14b is arranged in a row in the direction D orthogonal to the recording medium conveyance direction A is provided, and the first array 44 and the second array 45 are provided alternately in the recording medium conveyance direction A. Consequently, two first temperature control liquid flow paths 14a and two second temperature control liquid flow paths 14b are positioned around each pressure chamber 13 via four partition walls 15.

In a portion of the piezoelectric member 12 which forms the four partition walls 15 of the pressure chamber 13, an electrode wiring (not shown) for supplying a drive voltage is provided. When a drive voltage is applied to the four partition walls 15 for each pressure chamber 13, the four partition walls 15 are deformed, and liquid droplets are ejected from the ejection orifice 10 in the longitudinal direction of the pressure chamber 13.

In one example, the pressure chamber 13 has a cross-sectional shape of 120 μm×120 μm, the first temperature control liquid flow path 14a has a width of 346 μm and a height of 140 μm, and the second temperature control liquid flow path 14b has a width of 480 μm and a height of 310 μm. Each length of the pressure chamber 13 and the first and second temperature control liquid flow paths 14a and 14b is 10 mm, and the thickness of the four partition walls 15 is 120 μm.

The nozzle plate 8 includes multiple first outlet side flow paths 22a each of which connects an outlet opening 14c (see FIG. 2C) of the first temperature control liquid flow path 14a to the first temperature regulating unit 41. The first outlet side flow paths 22a are grooves to be connected to the multiple first temperature control liquid flow paths 14a adjacent to each other in the recording medium conveyance direction A and extend to the side surface of the nozzle plate 8 along the nozzle plate 8. The nozzle 9 is formed of the ejection orifice 10 and a widening portion 11 which communicates with the ejection orifice 10 and the pressure chamber 13 and has a flow path cross section larger than that of the ejection orifice 10. The ejection orifice 10 is formed in the nozzle plate 8, and the widening portion 11 is formed in a nozzle plate side intermediate plate 32 (described later). In one example, the nozzle plate 8 has a thickness of 200 μm, and the ejection orifice 10 has a cylindrical shape having a diameter of 10 μm and a length of 17 μm. The widening portion 11 has a prismatic shape having a cross-sectional shape of 50 μm×50 μm, and the first outlet side flow path 22a has a width of 160 μm and a height of 150 μm.

The nozzle plate side intermediate plate 32 is provided between the nozzle plate 8 and the piezoelectric member 12. The nozzle plate side intermediate plate 32 includes multiple second outlet side flow paths 22b for connecting outlet openings (not shown) of the second temperature control liquid flow path 14b to the second temperature regulating unit 42, in addition to the widening portion 11. The pressure chamber 13 and the first temperature control liquid flow path 14a pass through the nozzle plate side intermediate plate 32. The second outlet side flow path 22b is a groove to be connected to the multiple second temperature control liquid flow paths 14b and extend to the side surface of the nozzle plate side intermediate plate 32 along the nozzle plate side intermediate plate 32. In one example, the nozzle plate side intermediate plate 32 has a thickness of 200 μm, the second outlet side flow path 22b has a width of 350 μm and a height of 150 μm, and the widening portion 11 has a cross section of 70 μm×70 μm.

A diaphragm plate 17 includes a first inlet side flow path 21a which connects an inlet opening 14d (see FIG. 2C) of the first temperature control liquid flow path 14a to the first temperature regulating unit 41. The first inlet side flow path 21a is a groove which communicates with the multiple first temperature control liquid flow paths 14a adjacent to each other in the recording medium conveyance direction A and extend to the side surface of the diaphragm plate 17 along the diaphragm plate 17. Multiple diaphragm apertures 18 are provided so as to correspond to the multiple pressure chambers 13. Although not shown, the liquid ejection head 2 has a common liquid chamber in which liquid flows and which communicates with each diaphragm aperture 18. In one example, the diaphragm plate 17 has a thickness of 200 μm, the diaphragm aperture 18 which communicates with the pressure chamber 13 has a cross section of 70 μm×70 μm, and the first inlet side flow path 21a has a width of 160 μm and a height of 150 μm.

A diaphragm plate side intermediate plate 31 is provided between the piezoelectric member 12 and the diaphragm plate 17. The diaphragm plate side intermediate plate 31 includes a second inlet side flow path 21b which connects an inlet opening (not shown) of the second temperature control liquid flow path 14b to the second temperature regulating unit 42. The pressure chambers 13 and the first temperature control liquid flow paths 14a pass through the diaphragm plate side intermediate plate 31. The second inlet side flow path 21b is a groove to be connected to the multiple second temperature control liquid flow paths 14b and extend to the side surface of the diaphragm plate side intermediate plate 31 along the diaphragm plate side intermediate plate 31. In one example, the diaphragm plate side intermediate plate 31 has a thickness of 200 μm and the second inlet side flow path 21b has a width of 350 μm and a height of 150 μm.

As illustrated in FIGS. 8 and 9, the first outlet side flow path 22a formed in the nozzle plate 8 and the first inlet side flow path 21a formed in the diaphragm plate 17 are connected to each other via a first circulation liquid flow path 24a formed in a circulation liquid flow path forming member 23. Similarly, the second outlet side flow path 22b formed in the nozzle plate side intermediate plate 32 and the second inlet side flow path 21b formed in the diaphragm plate side intermediate plate 31 are connected to each other via a second circulation liquid flow path 24b formed in the circulation liquid flow path forming member 23. By allowing a first and a second temperature control liquid to flow in the two circulation flow paths thus formed, respectively, the temperature of the four partition walls 15 of the piezoelectric member 12 can be controlled effectively.

The first inlet side flow path 21a and the first outlet side flow path 22a may be formed in the nozzle plate 8 and the diaphragm plate 17, respectively. Similarly, the second inlet side flow path 21b and the second outlet side flow path 22b can be formed in the nozzle plate side intermediate plate 32 and the diaphragm plate side intermediate plate 31, respectively.

As long as the first and second temperature control liquid flow paths 14a and 14b extend from one end to the other end of the piezoelectric member 12, the first and second temperature control liquid flow paths 14a and 14b may use any of the nozzle plate 8, the nozzle plate side intermediate plate 32, the diaphragm plate 17, and the diaphragm plate side intermediate plate 31 as an inlet or an outlet. Thus, these four plates can include any of the first outlet side flow path 22a, the first inlet side flow path 21a, the second outlet side flow path 22b, or the second inlet side flow path 21b.

Further, in this embodiment, although the diaphragm plate side intermediate plate 31 is provided between the piezoelectric member 12 and the diaphragm plate 17, the diaphragm plate side intermediate plate 31 may be provided on a side of the diaphragm plate 17 opposite to the piezoelectric member 12. Further, the nozzle plate side intermediate plate 32 may be provided on a side of the nozzle plate 8 opposite to the piezoelectric member 12.

According to this embodiment, in the case of using the liquid ejection head 2 in which the nozzles 9 are arranged two-dimensionally so as to increase an effective nozzle pitch, the temperature of the four partition walls 15 of the pressure chamber 13 can also be controlled effectively.

### Fourth Embodiment

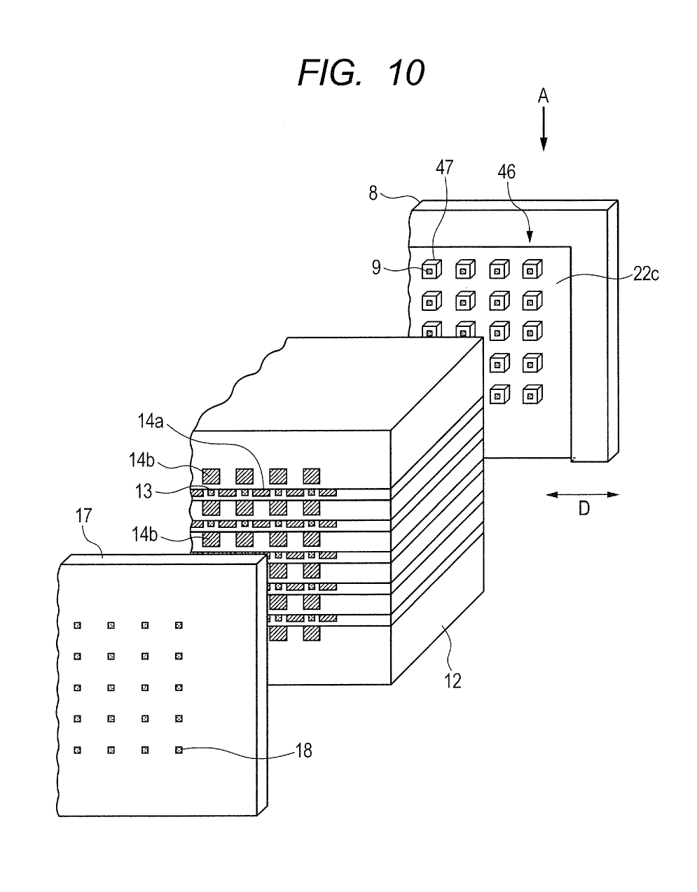

Next, a fourth embodiment of the present invention is described. The descriptions of the components which are common to those of the first to third embodiments are omitted. FIG. 10 illustrates a liquid ejection head 2 according to this embodiment.

In the liquid ejection head 2 of this embodiment, nozzles 9 (ejection orifices) are arranged two-dimensionally (in a lattice or non-lattice shape) so that an array 46 of the nozzles 9 (ejection orifices) arranged in the recording medium conveyance direction A is orthogonal to the recording medium conveyance direction A. Thus, identical pixels can be formed by the multiple nozzles 9, and unevenness caused by a difference in ejection amount among the nozzles 9 can be reduced.

In one example, a pressure chamber 13 has a width of 120 μm and a height of 120 μm, a first temperature control liquid flow path 14a has a width of 346 μm and a height of 140 μm, and a second temperature control liquid flow path 14b has a width of 360 μm and a height of 310 μm. The pressure chamber 13 and the first and second temperature control liquid flow paths 14a and 14b have a length of 10 mm, and four partition walls 15 have a thickness of 120 μm.

On a surface of a nozzle plate 8 facing a piezoelectric member 12, multiple projected portions 47 are provided two-dimensionally (in a lattice or non-lattice shape), each of which includes a flow path (nozzle 9) connecting an ejection orifice 10 to the pressure chamber 13 and projects toward the piezoelectric member 12. In one example, the nozzle plate 8 has a thickness of 200 μm, and the projected portion 47 has a prismatic shape of 240 μm×240 μm. The nozzle 9 is formed of the ejection orifice 10 and a widening portion 11. The ejection orifice 10 has a cylindrical shape having a diameter of 10 μm and a length of 17 μm, and the widening portion 11 has a cross section of 50 μm×50 μm. As illustrated in FIG. 10, an outlet side flow path 22c which communicates with the four temperature control liquid flow paths 14a and 14b adjacent to each pressure chamber 13 is formed around each projected portion 47 in which the nozzle 9 is formed. The outlet side flow path 22c is formed as multiple grooves which extend around each projected portion 47 and cross each other, and communicates with all the temperature control liquid flow paths 14a and 14b.

Similarly, although not shown, in a diaphragm plate 17 having a thickness of 200 μm, multiple projected portions projecting toward the piezoelectric member 12 are formed two-dimensionally. In one example, the projected portion has a prismatic shape of 240 μm×240 μm and a diaphragm aperture 18 has a cross section of 70 μm×70 μm. Grooves similar to those around the projected portions 47 are provided around the projected portions in which the diaphragm aperture 18 is formed, and thus, an inlet side flow path (not shown) which communicates with all the temperature control liquid flow paths 14a and 14b is formed.

According to this embodiment, the inlet side flow path and the outlet side flow path 22c are formed in the diaphragm plate 17 and the nozzle plate 8, respectively, and hence it is not necessary to provide an additional member. Further, all the temperature control liquid flow paths 14a and 14b communicate with one inlet side flow path and one outlet side flow path 22c, and hence one system of a temperature regulating unit suffices. Accordingly, the number of components can be reduced, and the temperature of the four partition walls 15 of each pressure chamber 13 can be controlled effectively while cost is suppressed.

### Fifth Embodiment

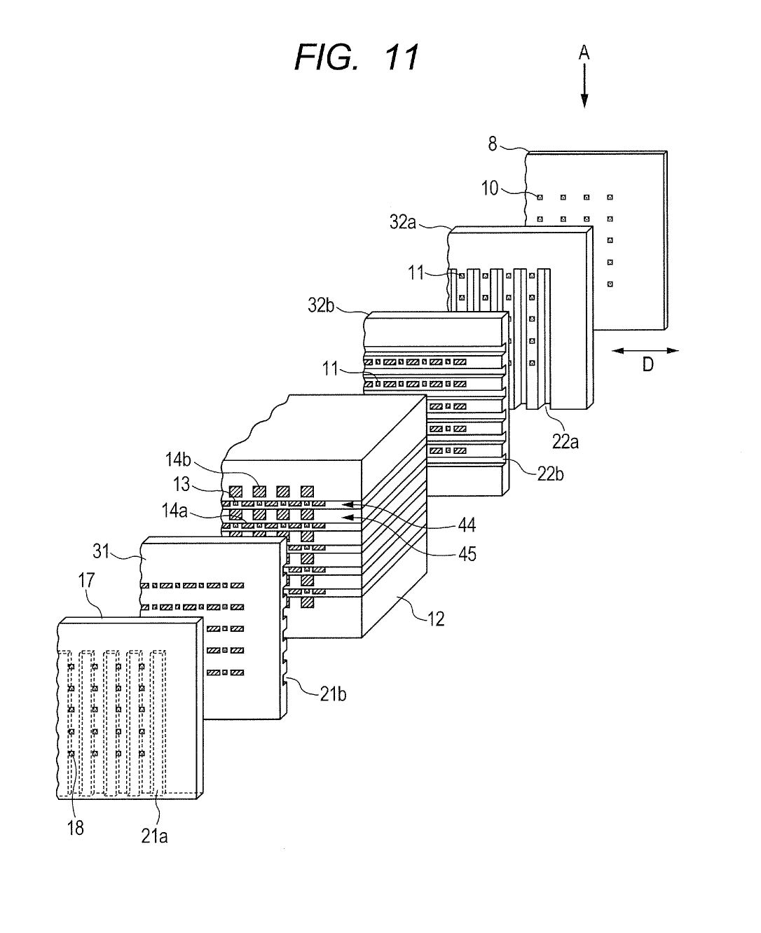

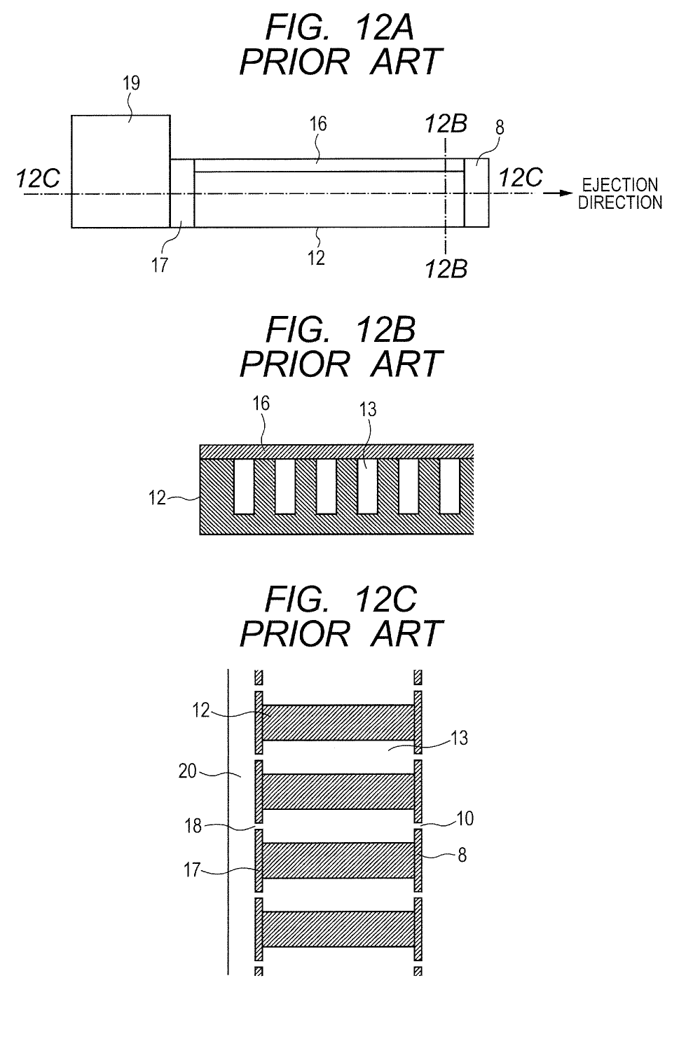

Next, a fifth embodiment of the present invention is described. The descriptions of the components which are common to those of the first to fourth embodiments are omitted. FIG. 11 illustrates a liquid ejection head 2 according to this embodiment.

In a nozzle plate 8, ejection orifices 10 are arranged in a lattice shape. In one example, the nozzle plate 8 has a thickness of 17 μm and includes the ejection orifices 10 having a diameter of 10 μm.

A pressure chamber 13 and a first temperature control liquid flow path 14a are provided alternately in a direction D orthogonal to a recording medium conveyance direction A and form a first array 44. Further, a second array 45 in which second temperature control liquid flow paths 14b are arranged in a row in the direction D orthogonal to the recording medium conveyance direction A is provided, and the first array 44 and the second array 45 are provided alternately in the recording medium conveyance direction A. The pressure chamber 13 is arranged in a lattice shape when seen in the cross-sections of the pressure chambers 13 orthogonal to a flow path, and the first arrays 44 are not shifted from each other in the direction D orthogonal to the recording medium conveyance direction A.

A first and a second nozzle plate side intermediate plate 32a and 32b are provided between a piezoelectric member 12 and the nozzle plate 8. The first nozzle plate side intermediate plate 32a is adjacent to the nozzle plate 8 and includes a first outlet side flow path 22a which communicates with the first temperature control liquid flow path 14a. In one example, the first nozzle plate side intermediate plate 32a has a thickness of 200 μm, and the first outlet side flow path 22a has a width of 160 μm and a height of 150 μm. The second nozzle plate side intermediate plate 32b is adjacent to the piezoelectric member 12 and includes a second outlet side flow path 22b which communicates with the second temperature control liquid flow path 14b. The second nozzle plate side intermediate plate 32b also includes a widening portion 11 which communicates with the pressure chamber 13 and the ejection orifice 10. In one example, the second nozzle plate side intermediate plate 32b has a thickness of 200 μm, and the second outlet side flow path 22b has a width of 350 μm and a height of 150 μm.

A diaphragm plate 17 includes a groove-shaped first inlet side flow path 21a which communicates with the first temperature control liquid flow path 14a and a diaphragm aperture 18 having a cross section of 70 μm×70 μm which communicates with the pressure chamber 13. In one example, the diaphragm plate 17 has a thickness of 200 μm, and the first inlet side flow path 21a has a width of 160 μm and a height of 150 μm.

A diaphragm plate side intermediate plate 31 is provided between the diaphragm plate 17 and the piezoelectric member 12 and includes a second inlet side flow path 21b which communicates with the second temperature control liquid flow path 14b. The pressure chamber 13 and the first temperature control liquid flow path 14a pass through the diaphragm plate side intermediate plate 31. In one example, the diaphragm plate side intermediate plate 31 has a thickness of 200 μm, and the second inlet side flow path 21b has a width of 350 μm and a height of 150 μm.

The first outlet side flow path 22a formed in the first nozzle plate side intermediate plate 32a and the first outlet side flow path 21a formed in the diaphragm plate 17 are connected to each other via a first circulation liquid flow path (not shown) formed in a circulation liquid flow path forming member (not shown). Similarly, the second outlet side flow path 22b formed in the second nozzle plate side intermediate plate 32b and the second inlet side flow path 21b formed in the diaphragm plate side intermediate plate 31 are connected to each other via a second circulation liquid flow path (not shown) formed in the circulation liquid flow path forming member. By allowing a temperature control liquid to flow in the two circulation flow paths thus formed, the temperature of the four partition walls 15 of each pressure chamber 13 can be controlled effectively.

In this embodiment, although the two nozzle plate side intermediate plates 32a and 32b are provided between the piezoelectric member 12 and the nozzle plate 8, the two nozzle plate side intermediate plates 32a and 32b may be provided on a side of the nozzle plate 8 opposite to the piezoelectric member 12. Alternatively, one of the nozzle plate side intermediate plates 32a and 32b may be provided between the piezoelectric member 12 and the nozzle plate 8, and the other one of the nozzle plate side intermediate plates 32a and 32b may be provided on the side of the nozzle plate 8 opposite to the piezoelectric member 12.

In this embodiment, the ejection orifice 10 and the widening portion 11 are formed of different members, and hence it is not necessary to form a structure having a level difference in one member, which facilitates the production of the liquid ejection head 2.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2011-204601, filed Sep. 20, 2011, which is hereby incorporated by reference herein in its entirety.

1. A liquid ejection head, comprising:
a pressure chamber in which a liquid flows, at least a part of a wall surface of the pressure chamber being formed of a piezoelectric member;
an ejection orifice for ejecting the liquid in the pressure chamber pressurized by deformation of the piezoelectric member;
a temperature control liquid flow path in which a temperature control liquid flows, the temperature control liquid flow path being provided independently from the pressure chamber and formed so as to be adjacent to the pressure chamber via the wall surface of the pressure chamber, at least a part of a wall surface of the temperature control liquid flow path being formed of the piezoelectric member; and
a circulation liquid flow path communicating with the temperature control liquid flow path, for circulating the temperature control liquid.

2. A liquid ejection head according to claim 1, further comprising a nozzle plate including the ejection orifice, and a diaphragm plate including a diaphragm aperture which communicates with the pressure chamber and has a cross section smaller than a cross section of the pressure chamber in a direction orthogonal to a liquid flow direction.

3. A liquid ejection head according to claim 2, further comprising a temperature regulating unit for regulating a temperature of the temperature control liquid.

4. A liquid ejection head according to claim 2, wherein the diaphragm plate includes one of an outlet side flow path for connecting an outlet opening of the temperature control liquid flow path to the circulation liquid flow path and an inlet side flow path for connecting the circulation liquid flow path to an inlet opening of the temperature control liquid flow path.

5. A liquid ejection head according to claim 2, wherein the nozzle plate includes one of an outlet side flow path for connecting an outlet opening of the temperature control liquid flow path to the circulation liquid flow path and an inlet side flow path for connecting the circulation liquid flow path to an inlet opening of the temperature control liquid flow path.

6. A liquid ejection head according to claim 2, wherein the piezoelectric member includes one of an outlet side flow path for connecting an outlet opening of the temperature control liquid flow path to the circulation liquid flow path and an inlet side flow path for connecting the circulation liquid flow path to an inlet opening of the temperature control liquid flow path.

7. A liquid ejection head according to claim 2, further comprising a nozzle plate side intermediate plate between the nozzle plate and the piezoelectric member, wherein the nozzle plate side intermediate plate includes one of an outlet side flow path for connecting an outlet opening of the temperature control liquid flow path to the circulation liquid flow path and an inlet side flow path for connecting the circulation liquid flow path to an inlet opening of the temperature control liquid flow path, and
wherein the nozzle plate side intermediate plate further includes a widening portion which communicates with the ejection orifice and the pressure chamber and has a flow path cross section larger than a flow path cross section of the ejection orifice.

8. A liquid ejection head according to claim 1, further comprising a plurality of the ejection orifices arranged in a direction orthogonal to a recording medium conveyance direction,
wherein the piezoelectric member includes a plurality of the pressure chambers corresponding to the plurality of the ejection orifices, and
wherein the temperature control liquid flow path and the pressure chamber are alternately provided in the piezoelectric member in the direction orthogonal to the recording medium conveyance direction.

9. A liquid ejection head according to claim 2,
wherein the nozzle plate includes a plurality of the ejection orifices arranged two-dimensionally,
wherein the piezoelectric member includes a plurality of the pressure chambers corresponding to the plurality of the ejection orifices, and
wherein, on a surface of the nozzle plate facing the piezoelectric member, the nozzle plate further includes two-dimensionally a plurality of projected portions each including a flow path connecting the ejection orifice to the pressure chamber and projecting toward the piezoelectric member, and
wherein the temperature control liquid flow path is formed as a plurality of grooves extending around the plurality of projected portions and crossing each other.

10. A liquid ejection head according to claim 2, further comprising a second temperature control liquid flow path in which a second temperature control liquid flows, the second temperature control liquid flow path being provided in the piezoelectric member independently from the pressure chamber and the temperature control liquid flow path and being adjacent to the pressure chamber via the piezoelectric member, and a second circulation liquid flow path which communicates with the second temperature control liquid flow path.

11. A liquid ejection head according to claim 10, further comprising a second temperature regulating unit for regulating a temperature of the second temperature control liquid.

12. A liquid ejection head according to claim 10, wherein the diaphragm plate includes one of an outlet side flow path for connecting an outlet opening of the temperature control liquid flow path to the circulation liquid flow path, an inlet side flow path for connecting the circulation liquid flow path to an inlet opening of the temperature control liquid flow path, a second outlet side flow path for connecting an outlet opening of the second temperature control liquid flow path to the second circulation liquid flow path, and a second inlet side flow path for connecting the second circulation liquid flow path to an inlet opening of the second temperature control liquid flow path.

13. A liquid ejection head according to claim 10, wherein the nozzle plate includes one of an outlet side flow path for connecting an outlet opening of the temperature control liquid flow path to the circulation liquid flow path, an inlet side flow path for connecting the circulation liquid flow path to an inlet opening of the temperature control liquid flow path, a second outlet side flow path for connecting an outlet opening of the second temperature control liquid flow path to the second circulation liquid flow path, and a second inlet side flow path for connecting the second circulation liquid flow path to an inlet opening of the second temperature control liquid flow path.

14. A liquid ejection head according to claim 10, wherein the piezoelectric member includes one of an outlet side flow path for connecting an outlet opening of the temperature control liquid flow path to the circulation liquid flow path, an inlet side flow path for connecting the circulation liquid flow path to an inlet opening of the temperature control liquid flow path, a second outlet side flow path for connecting an outlet opening of the second temperature control liquid flow path to the second circulation liquid flow path, and a second inlet side flow path for connecting the second circulation liquid flow path to an inlet opening of the second temperature control liquid flow path.

15. A liquid ejection head according to claim 10, further comprising a first nozzle plate side intermediate plate between the nozzle plate and the piezoelectric member and a second nozzle plate side intermediate plate between the first nozzle plate side intermediate plate and the piezoelectric member,
wherein each of the first nozzle plate side intermediate plate and the second nozzle plate side intermediate plate includes one of an outlet side flow path for connecting an outlet opening of the temperature control liquid flow path to the circulation liquid flow path, an inlet side flow path for connecting the circulation liquid flow path to an inlet opening of the temperature control liquid flow path, a second outlet side flow path for connecting an outlet opening of the second temperature control liquid flow path to the second circulation liquid flow path, and a second inlet side flow path for connecting the second circulation liquid flow path to an inlet opening of the second temperature control liquid flow path, and wherein the first nozzle plate side intermediate plate further includes a widening portion which communicates with the ejection orifice and the pressure chamber and has a flow path cross section larger than a flow path cross section of the ejection orifice.

16. A liquid ejection head according to claim 10, further comprising a diaphragm plate side intermediate plate between the diaphragm plate and the piezoelectric member,
wherein the diaphragm plate side intermediate plate includes one of an outlet side flow path for connecting an outlet opening of the temperature control liquid flow path to the circulation liquid flow path, an inlet side flow path for connecting the circulation liquid flow path to an inlet opening of the temperature control liquid flow path, a second outlet side flow path for connecting an outlet opening of the second temperature control liquid flow path to the second circulation liquid flow path, and a second inlet side flow path for connecting the second circulation liquid flow path to an inlet opening of the second temperature control liquid flow path.

17. A liquid ejection head according to claim 10,
wherein the nozzle plate includes a plurality of the ejection orifices arranged in a lattice shape,
wherein the piezoelectric member includes a plurality of the pressure chambers corresponding to the plurality of the ejection orifices, and
wherein, in the piezoelectric member, an array in which the pressure chamber and the temperature control liquid flow path are provided alternately in a direction orthogonal to a recording medium conveyance direction and a second array in which the second temperature control liquid flow path is arranged in a row in the direction orthogonal to the recording medium conveyance direction are provided alternately in the recording medium conveyance direction of the pressure chamber.

18. A liquid ejection head according to claim 10,
wherein the nozzle plate includes a plurality of ejection orifice arrays including a plurality of the ejection orifices arranged in a direction orthogonal to a recording medium conveyance direction, the plurality of ejection orifice arrays being provided at an interval in the recording medium conveyance direction so as to be shifted from each other in the direction orthogonal to the recording medium conveyance direction,
wherein the piezoelectric member includes a plurality of the pressure chambers corresponding to the plurality of the ejection orifices, and
wherein in the piezoelectric member, an array in which the pressure chamber and the temperature control liquid flow path are provided alternately in the direction orthogonal to the recording medium conveyance direction and a second array in which the second temperature control liquid flow path is arranged in a row in the direction orthogonal to the recording medium conveyance direction are provided alternately in the recording medium conveyance direction of the pressure chamber.

19. A liquid ejection head according to claim 1, wherein a plurality of the diaphragm apertures are provided so as to correspond to a plurality of the pressure chambers, and
wherein the liquid ejection head further comprises a common liquid chamber in which the liquid flows the common liquid chamber communicating with each of the plurality of the pressure chambers via each of the plurality of the diaphragm apertures.

20. A liquid ejection apparatus, comprising the liquid ejection head according to claim 1.
